(19) United States
(12) Patent Application Publication
(10) Pub. No.: US 2015/0065003 A1
(43) Pub. Date: Mar. 5, 2015

(54) NONWOVEN FABRIC COMPOSITE AND METHOD FOR MAKING THE SAME

(71) Applicant: KANG NA HSIUNG ENTERPRISE CO., LTD., Tainan (TW)

(72) Inventors: Jung-Chi Tai, Tainan City (TW); Ho-Hsi Yang, Tainan City (TW); Chien-Chung Su, Tainan City (TW)

(73) Assignee: KANG NA HSIUNG ENTERPRISE CO., LTD., Tainan (TW)

(21) Appl. No.: 14/216,606

(22) Filed: Mar. 17, 2014

(30) Foreign Application Priority Data
Aug. 30, 2013 (TW) 102131252

(51) Int. Cl. B32B 5/26; D04H 1/498; B32B 5/02

(52) U.S. Cl. CPC B32B 5/26; B32B 5/022; D04H 1/498; B32B 2250/04; B32B 2250/20; B32B 2307/54; B32B 2307/726; B32B 2317/12; B32B 2367/00; B32B 2262/062; B32B 2262/0284; D10B 2201/00; D10B 2331/04
USPC 442/334; 28/104

(57) ABSTRACT

A nonwoven fabric composite includes a spunbond nonwoven fabric layer having a plurality of bonded fibers, an air-laid nonwoven pulp web layer having a plurality of pulp fibers and overlying the spunbond nonwoven fabric layer to cooperatively form an inner laminate with the pulp web layer, and a pair of nonwoven carded fiber web layers each having a plurality of carded fibers. The nonwoven carded fiber web layers sandwich the inner laminate therebetween. The bonded fibers, the pulp fibers, and the carded fibers are entangled with one another. A ratio of tensile strength of the nonwoven fabric composite in a machine direction to tensile strength of the nonwoven fabric composite in a cross-machine direction is not greater than 4.

### CROSS-REFERENCE TO RELATED APPLICATION

This application claims priority of Taiwanese application no. 102131252, filed on Aug. 30, 2013.

### BACKGROUND OF THE INVENTION

1. Field of the Invention

This invention relates to a nonwoven fabric composite, more particularly to a nonwoven fabric composite that can provide good liquid absorption and enhanced physical properties (such as tensile strength, elongation, etc.) in both machine and cross-machine directions, and a method for making the same.

2. Description of the Related Art

One of the inventors of this application has proposed a process for producing a nonwoven composite fabric in U.S. Pat. No. 6,273,978. Conventional nonwoven composite fabrics or fabric composites, such as that made by the process of said US patent, have the drawback that there is a relatively large difference between tensile strength in the machine direction and tensile strength in the cross-machine direction, and are thus likely to deform in a state of use.

### SUMMARY OF THE INVENTION

Therefore, an object of the present invention is to provide a nonwoven fabric composite that that can provide good liquid absorption and that is unlikely to deform in a state of use, and a method for making the same.

According to the first aspect of this invention, a nonwoven fabric composite includes: a spunbond nonwoven fabric layer which extends in a machine direction and a cross-machine direction, and which has a plurality of bonded fibers; an air-laid nonwoven pulp web layer which has a plurality of pulp fibers, and which overlies the spunbond nonwoven fabric layer, at least some of the pulp fibers being entangled with some of the bonded fibers, the spunbond nonwoven fabric layer and the air-laid nonwoven pulp web layer cooperatively forming an inner laminate; and a pair of nonwoven carded fiber web layers, each of which has a plurality of carded fibers that are carded along the machine direction and that have a fiber length greater than 10 mm, and which sandwich therebetween the inner laminate, at least some of the carded fibers being entangled with some of the pulp fibers, at least some of the carded fibers being entangled with some of the bonded fibers such that a ratio of tensile strength of the nonwoven fabric composite in the machine direction to tensile strength of the nonwoven fabric composite in the cross-machine direction is not greater than 4.

According to the second aspect of this invention, a method for making a nonwoven fabric composite includes the steps of: (a) providing a spunbond nonwoven fabric layer which extends in a machine direction and a cross-machine direction, and which is formed to have a plurality of bonded fibers; (b) causing an air-laid nonwoven pulp web layer to overlie the spunbond nonwoven fabric layer so as to obtain an intermediate stack, the air-laid nonwoven pulp web layer having a plurality of pulp fibers; (c) sandwiching the intermediate stake between a pair of nonwoven carded fiber web layers to obtain a sandwich laminate, each of the nonwoven carded fiber web layers having a plurality of carded fibers that are carded in the machine direction and that have a fiber length greater than 10 mm; and (d) subjecting the sandwich laminate to a fluid jet treatment to effect mechanical entanglement among the bonded fibers, the pulp fibers, and the carded fibers, thereby obtaining a nonwoven fabric composite which has a ratio of tensile strength in the machine direction to tensile strength in the cross-machine direction not greater than 4.

### BRIEF DESCRIPTION OF THE DRAWING

Other features and advantages of the present invention will become apparent in the following detailed description of the preferred embodiment of the invention, with reference to the accompanying drawing, in which:

FIG. 1 is a fragmentary cross-sectional view of the preferred embodiment of a nonwoven fabric composite according to this invention.

### DETAILED DESCRIPTION OF THE PREFERRED EMBODIMENT

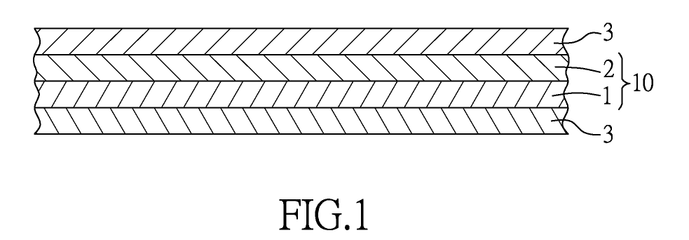

Referring to FIG. 1, the preferred embodiment of a nonwoven fabric composite according to this invention is shown to include a spunbond nonwoven fabric layer 1, an air-laid nonwoven pulp web layer 2, and a pair of nonwoven carded fiber web layers 3. The nonwoven fabric composite has amass density ranging from 25 g/m² to 150 g/m², and a thickness ranging from 0.1 mm to 10 mm.

The spunbond nonwoven fabric layer 1 can be made by any conventional methods. For example, the spunbond nonwoven fabric layer 1 is made by subjecting a polymer to processes of melting, extruding, drawing, and cooling to obtain a plurality of fibers, followed by bonding the fibers using thermal bonding, chemical bonding, mechanical bonding, etc. The polymer can be, but is not limited to, polyethylene, polypropylene, polyethylene terephthalate, or a combination of polyethylene and polypropylene.

In the preferred embodiment, the spunbond nonwoven fabric layer 1 extends in a machine direction and a cross-machine direction, and has a plurality of bonded fibers. Preferably, the spunbond nonwoven fabric layer 1 has a weight percent ranging from 8 wt % to 50 wt % based on the total weight of the nonwoven fabric composite.

The air-laid nonwoven pulp web layer 2 has a plurality of pulp fibers, and overlies the spunbond nonwoven fabric layer 1. At least some of the pulp fibers are entangled with some of the bonded fibers. The spunbond nonwoven fabric layer 1 and the air-laid nonwoven pulp web layer 2 cooperatively form an inner laminate 10. The pulp fibers can be paper pulp fibers or wood pulp fibers. The pulp fibers have a fiber length ranging from 1 mm to 5 mm, and a fineness ranging from 0.1 denier to 10 denier. Preferably, the air-laid nonwoven pulp web layer 2 has a weight percent ranging from 5 wt % to 60 wt % based on the total weight of the nonwoven fabric composite.

Each of the nonwoven carded fiber web layers 3 has a plurality of carded fibers which are carded along the machine direction and which have a fiber length greater than 10 mm. In this embodiment, the carded fibers have a fiber length ranging from 10 mm to 76 mm, and a fineness ranging from 1 denier to 6 denier. The nonwoven carded fiber web layers 3 have a weight percent ranging from 10 wt % to 80 wt % based on the total weight of the nonwoven fabric composite. The carded fibers are made from natural fibers, chemical fibers or combinations thereof. The natural fibers can be seed fibers (e.g., cotton), bast fibers (e.g., flax, hemp), leaf fibers (e.g., manila hemp), fruit fibers (e.g., coconut), animal fibers (e.g., silk, animal skin), etc. The chemical fibers can be regenerated fibers (e.g., rayon), semi-synthetic fibers (e.g., cellulose acetate), and synthetic fibers. The synthetic fibers can be made from, but are not limited to, polyethylene, polypropylene, polyethylene terephthalate, polyamide, etc. Preferably, the carded fibers are made from at least one material selected from the group consisting of polyethylene, polypropylene, polyethylene terephthalate, rayon, and cotton.

The nonwoven carded fiber web layers 3 sandwich therebetween the inner laminate 10. At least some of the carded fibers are entangled with some of the pulp fibers, and at least some of the carded fibers are entangled with some of the bonded fibers such that a ratio of tensile strength of the nonwoven fabric composite in the machine direction to tensile strength of the nonwoven fabric composite in the cross-machine direction is not greater than 4. In the this preferred embodiment, the ratio of the tensile strength of the nonwoven fabric composite in the machine direction to the tensile strength of the nonwoven fabric composite in the cross-machine direction is not greater than 2.

A method for making the nonwoven fabric composite according to the preferred embodiment of this embodiment includes the following steps (a) to (d).

In step (a), a spunbond nonwoven fabric layer 1 is provided. The spunbond nonwoven fabric layer 1 extends in a machine direction and a cross-machine direction, and is formed to have a plurality of bonded fibers.

In step (b), an air-laid nonwoven pulp web layer 2 is disposed to overlie the spunbond nonwoven fabric layer 1 to obtain an intermediate stack. The air-laid nonwoven pulp web layer 2 has a plurality of pulp fibers.

In step (c), the intermediate stack is sandwiched between a pair of nonwoven carded fiber web layers 3 to obtain a sandwich laminate. Each of the nonwoven carded fiber web layers 3 has a plurality of carded fibers that are carded in the machine direction.

In step (d), the sandwich laminate is subjected to a fluid jet treatment to effect mechanical entanglement among the bonded fibers, the pulp fibers, and the carded fibers, thereby obtaining a nonwoven fabric composite which has a ratio of tensile strength in the machine direction to tensile strength in the cross-machine direction not greater than 4. In the this preferred embodiment, the ratio of the tensile strength of the nonwoven fabric composite in the machine direction to the tensile strength of the nonwoven fabric composite in the cross-machine direction is not greater than 2. Preferably, the fluid jet treatment is a water jet treatment.

The method of the present invention will now be explained in more detail below by way of the following Example 1 and Comparative Example 1.

### Example 1

Paper pulp fibers (fiber length: 1 mm˜5 mm) were entrained in a gas stream at a flow rate of 130 CMM (cubic meter per minute), and were then fed onto a spunbond nonwoven fabric layer which was moved along a machine direction at a rate of 50 M/min to form an air-laid nonwoven pulp web layer on the spunbond nonwoven fabric layer. The air-laid nonwoven pulp web layer extended in the machine direction and a cross-machine direction. The spunbond nonwoven fabric layer was made of polypropylene (PP), and had a mass density of 13 g/m². The air-laid nonwoven pulp web layer was heated at 135° C. and was adhered to the spunbond nonwoven fabric layer by applying suction to a surface of the spunbond nonwoven fabric layer distal from the air-laid nonwoven pulp web layer, followed by passage of the air-laid nonwoven pulp web layer and the spunbond nonwoven fabric layer through a nip between a pair of pressing rollers, thereby obtaining an intermediate stack. A pair of nonwoven carded fiber web layers were advanced along the machine direction at a rate of 50 M/min to sandwich the intermediate stack therebetween to thereby form a sandwich laminate. Each of the nonwoven carded fiber web layers had a mass density of 22 g/m², and included a plurality of carded fibers that had a fiber length ranging from 10 mm to 76 mm, that were made from polyethylene terephthalate (PET), and that were carded along the machine direction. The sandwich laminate was advanced along the machine direction and subjected to a water jet treatment (water jet pressure: 50 bar), and was then dried to obtain a nonwoven fabric composite. The weight percentages of the materials used for forming the nonwoven fabric composite of Example 1 are shown in Table 1.

### Comparative Example 1

Paper pulp fibers (fiber length: 1 mm˜5 mm) were entrained in a gas stream at a flow rate of 130 CMM (cubic meter per minute), and were then fed onto a first nonwoven carded fiber web layer which was moved along a machine direction at a rate of 50 M/min to form an air-laid nonwoven pulp web layer on the first nonwoven carded fiber web layer. The air-laid nonwoven pulp web layer was heated at 135° C. and was adhered to the first nonwoven carded fiber web layer by applying suction to a surface of the first nonwoven carded fiber web layer distal from the air-laid nonwoven pulp web layer, followed by passage of the air-laid nonwoven pulp web layer and the first nonwoven carded fiber web layer through a nip between a pair of pressing rollers. Then, the second nonwoven carded fiber web layer was advanced along the machine direction at a rate of 50 M/min to overlie the air-laid nonwoven pulp web layer so as to obtain a laminate. The laminate was advanced along the machine direction and subjected to a water jet treatment (water jet pressure: 50 bar), and was then dried to obtain a nonwoven fabric composite. The weight percentages of the materials used for forming the nonwoven fabric composite of Comparative Example 1 are shown in Table 1.

The nonwoven fabric composites of Example 1 and Comparative Example 1 were subjected to the following tests, and the test results are shown in Table 1.

<Mass Density>

A nonwoven fabric composite to be tested was tested according to ASTM D3776-85 at a temperature of 23±0.5° C. and a relative humidity of 65±2% under normal pressure.

<Tensile Strength>

A nonwoven fabric composite to be tested was cut into a piece of 150 mm×25.4 mm, and a tensile strength at break was then measured according to ASTM D-1117.

<Elongation>

A nonwoven fabric composite to be tested was cut into a piece of 150 mm×25.4 mm, and elongation at break was then measured according to ASTM D-1117.

TABLE 1

| | | | Comparative |
|---|---|---|---|
| | | Example 1 | Example 1 |
| Nonwoven | PET (wt %) | 26 | 40 |
| carded fiber | | | |
| web layers | | | |
| Spunbond | PP (wt %) | 24 | — |
| nonwoven | | | |
| fabric layer | | | |
| Air-laid | Paper pulp | 50 | 60 |
| nonwoven pulp | fiber (wt %) | | |
| web layer | | | |

| | | |
|---|---|---|
| Mass density (g/m²) | 40.0 | 40.0 |
| Thickness (mm) | 0.53 | 0.49 |
| Tensile strength in a machine | 4.16 | 2.53 |
| direction (Kgf/25 mm) | | |
| Tensile strength in a | 3.82 | 0.61 |
| cross-machine direction | | |
| (Kgf/25 mm) | | |
| Elongation in a machine | 32 | 27.8 |
| direction (%) | | |
| Elongation in a cross-machine | 45 | 115 |
| direction (%) | | |
| MD/CD ratio* | 1.09 | 4.15 |

*MD/CD ratio means a ratio of tensile strength in the machine direction (MD) to tensile strength in the cross-machine direction (MD).

From the results shown in Table 1, the nonwoven fabric composite of Example 1 is better than that of Comparative Example 1 in tensile strength and elongation in both the machine direction and the cross-machine direction. Especially, the MD/CD ratio of the nonwoven fabric composite of Example 1 is smaller than that of Comparative Example 1. That is, the difference between tensile strength in the machine direction and tensile strength in the cross-machine direction in the nonwoven fabric composite of Example 1 is smaller. As such, the nonwoven fabric composite of Example 1 is less likely to deform when it is in a state of use.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A nonwoven fabric composite comprising:
a spunbond nonwoven fabric layer which extends in a machine direction and a cross-machine direction, and which has a plurality of bonded fibers;
an air-laid nonwoven pulp web layer which has a plurality of pulp fibers, and which overlies said spunbond nonwoven fabric layer, at least some of said pulp fibers being entangled with some of said bonded fibers, said spunbond nonwoven fabric layer and said air-laid nonwoven pulp web layer cooperatively forming an inner laminate; and
a pair of nonwoven carded fiber web layers, each of which has a plurality of carded fibers that are carded along the machine direction and that have a fiber length greater than 10 mm, and which sandwich therebetween said inner laminate, at least some of said carded fibers being entangled with some of said pulp fibers, at least some of said carded fibers being entangled with some of said bonded fibers such that a ratio of tensile strength of said nonwoven fabric composite in the machine direction to tensile strength of said nonwoven fabric composite in the cross-machine direction is not greater than 4.

2. The nonwoven fabric composite of claim 1, wherein said air-laid nonwoven pulp web layer has a weight percent ranging from 5 wt % to 60 wt % based on the total weight of said nonwoven fabric composite.

3. The nonwoven fabric composite of claim 1, wherein said spunbond nonwoven fabric layer has a weight percent ranging from 8 wt % to 50 wt % based on the total weight of said nonwoven fabric composite.

4. The nonwoven fabric composite of claim 1, wherein said nonwoven carded fiber web layers have a weight percent ranging from 10 wt % to 80 wt % based on the total weight of said nonwoven fabric composite.

5. A method for making a nonwoven fabric composite, comprising the steps of:
(a) providing a spunbond nonwoven fabric layer which extends in a machine direction and a cross-machine direction, and which is formed to have a plurality of bonded fibers;
(b) causing an air-laid nonwoven pulp web layer to overlie the spunbond nonwoven fabric layer so as to obtain an intermediate stack, the air-laid nonwoven pulp web layer having a plurality of pulp fibers;
(c) sandwiching the intermediate stake between a pair of nonwoven carded fiber web layers to obtain a sandwich laminate, each of the nonwoven carded fiber web layers having a plurality of carded fibers that are carded in the machine direction and that have a fiber length greater than 10 mm; and
(d) subjecting the sandwich laminate to a fluid jet treatment to effect mechanical entanglement among the bonded fibers, the pulp fibers, and the carded fibers, thereby obtaining a nonwoven fabric composite which has a ratio of tensile strength in the machine direction to tensile strength in the cross-machine direction not greater than 4.

6. The method of claim 5, wherein the fluid jet treatment is a water jet treatment.

7. The method of claim 5, wherein the air-laid nonwoven pulp web layer has a weight percent ranging from 5 wt % to 60 wt % based on the total weight of the nonwoven fabric composite.

8. The method of claim 5, wherein the spunbond nonwoven fabric has a weight percent ranging from 8 wt % to 50 wt % based on the total weight of the nonwoven fabric composite.

9. The method of claim 5, wherein the nonwoven carded fiber web layers have a weight percent ranging from 10 wt % to 80 wt % based on the total weight of the nonwoven fabric composite.
